(19) United States
(12) Patent Application Publication
(10) Pub. No.: US 2022/0012781 A1
(43) Pub. Date: Jan. 13, 2022

(54) INFORMATION PROCESSING APPARATUS, INFORMATION PROCESSING METHOD, AND TERMINAL APPARATUS

(71) Applicant: Toyota Jidosha Kabushiki Kaisha, Toyota-shi Aichi-ken (JP)

(72) Inventors: Shin Sakurada, Toyota-shi (JP); Hirotada Nakanishi, Toyota-shi (JP); Atsushi Inoue, Nagoya-shi (JP); Hideo Hasegawa, Nagoya-shi (JP); Yurika Tanaka, Yokosuka-shi (JP); Genshi Kuno, Kasugai-shi (JP)

(21) Appl. No.: 17/354,024

(22) Filed: Jun. 22, 2021

(30) Foreign Application Priority Data
Jul. 8, 2020 (JP) 2020-118068

(51) Int. Cl. G06Q 30/02; G06K 9/00; G10L 15/22; G10L 25/63; G06F 3/14; G06Q 30/06; G09F 9/30

(52) U.S. Cl. CPC G06Q 30/0281; G06K 9/00335; G06K 9/00302; G06K 9/00624; G10L 15/22; G09F 27/00; G06F 3/14; G06Q 30/0631; G06Q 30/0623; G09F 9/30; G10L 25/63

(57) ABSTRACT

An information processing apparatus includes: an information acquisition interface configured to acquire information related to a behavior of a user; and a controller configured to estimate a product required by the user based on the information related to the behavior of the user, generate information supporting a purchase of the estimated product, and cause an output interface to output the generated information.

### CROSS-REFERENCE TO RELATED APPLICATION

This application claims priority to Japanese Patent Application No. 2020-118068 filed on Jul. 8, 2020, the entire contents of which are incorporated herein by reference.

### TECHNICAL FIELD

The present disclosure relates to an information processing apparatus, an information processing method, and a terminal apparatus.

### BACKGROUND

Based on wish lists of products that users want to purchase, known apparatuses deliver, to their portable terminals, information about shops which deal with the products (for example, Patent Literature [PTL] 1).

### CITATION LIST

### Patent Literature

PTL 1: JP 2009-252152 A

### SUMMARY

According to an apparatus described in PTL 1, a user needs to make effort of, for example, designating products that he or she wishes to purchase, so as to receive information from the apparatus. It is desired that the user can obtain the information from the apparatus without effort.

It would be helpful to generate information that is to be delivered to a user while saving effort for the user.

An information processing apparatus according to an embodiment of the present disclosure includes:

an information acquisition interface configured to acquire information related to a behavior of a user; and

a controller configured to estimate a product required by the user based on the information related to the behavior of the user, generate information supporting a purchase of the estimated product, and cause an output interface to output the generated information.

An information processing method according to an embodiment of the present disclosure includes:

acquiring information related to a behavior of a user;

estimating a product required by the user based on the information related to the behavior of the user; and

outputting information necessary for a purchase of the estimated product.

A terminal apparatus to be in possession of a user according to an embodiment of the present disclosure includes:

an information acquisition interface configured to acquire information necessary for a purchase of a product, the product being estimated to be required by the user based on information related to a behavior of the user; and

an output interface configured to notify the user of the information necessary for the purchase of the product.

According to an information processing apparatus, an information processing method, and a terminal apparatus according to an embodiment of the present disclosure, information that is to be delivered to a user can be generated while saving effort for the user.

### BRIEF DESCRIPTION OF THE DRAWINGS

In the accompanying drawings:

FIG. 1 is a schematic diagram illustrating an example configuration of an information processing system according to an embodiment;

FIG. 2 is a block diagram illustrating an example configuration of the information processing system according to the embodiment; and

FIG. 3 is a flowchart illustrating an example of a procedure of an information processing method.

### DETAILED DESCRIPTION

(Information Processing System 1)

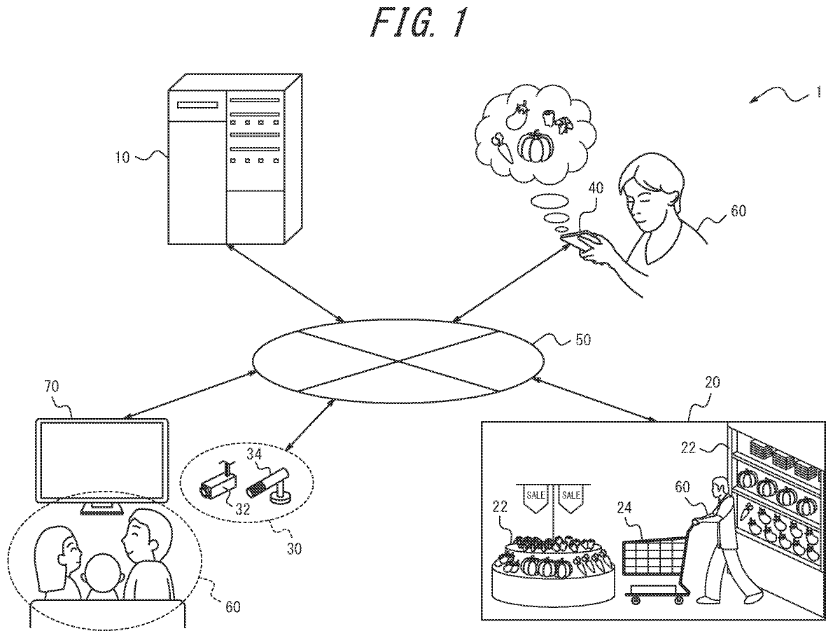

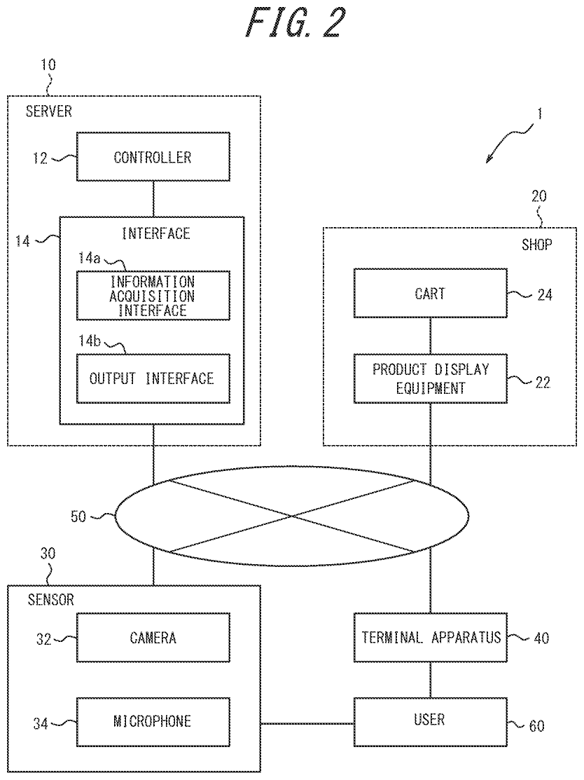

As illustrated in FIG. 1 and FIG. 2, an information processing system 1 according to an embodiment includes a server 10. The information processing system 1 further includes a sensor 30 for detecting information related to a behavior of a user 60. The sensor 30 may include, for example, a camera 32, a microphone 34, or the like. The information processing system 1 further includes a terminal apparatus 40 and/or product display equipment 22 installed at a shop 20. The server 10, and the terminal apparatus 40 and/or the product display equipment 22 are connected to a network 50 and can communicate with each other. Each of the server 10, the terminal apparatus 40, and the product display equipment 22 is not limited to one and may be two or more in number.

The information processing system 1 provides a purchase support service that allows the user 60 an easy purchase of products. The purchase support service may be operated by an operator of the shop 20 that sells the products or may be operated by various other business operators. Specifically, for example, the following service is provided as the purchase support service.

The server 10 acquires the information related to the behavior of the user 60. The information related to the behavior of the user 60 is also referred to as behavior information. The server 10 estimates one or more products required by the user 60 based on the behavior of the user 60. The server 10 generates information supporting the purchase of the estimated products and outputs the generated information. The information supporting the purchase of the products is also referred to as purchase information. The purchase information may include information necessary for the purchase of the products. The information necessary for the purchase of the products may include information related to names or appearances of the products. The purchase information may include, for example, information that notifies the user 60 of positions in the shop 20 at which the products are displayed. The purchase information may include, for example, control information that specifies actions that the product display equipment 22 installed at the shop 20 is to take for the estimated products when the user 60 visits the shop 20.

Hereinafter, a specific configuration and specific operations of the information processing system 1 to provide the purchase support service will be described.

<Sensor 30>

The sensor 30 may include various devices that detect the behavior information. The sensor 30 outputs the detected behavior information to the server 10.

The sensor 30 may include the camera 32. The camera 32 captures a still image or a moving image including the user 60 and outputs image data to the server 10. The image data may include an image by which appearance, such as facial expressions or complexions, of the user 60 can be determined. The image data may include an image from which the line of sight of the user 60 can be determined. The image data may include an image in which the state of surroundings of the user 60 is captured. The image data may include an image from which a visible object located in the line of sight of the user 60 can be determined. The image data may include an image from which biological information, such as the state of the pupil, of the user 60 can be determined. The image data may include an image from which movements of the user 60 can be determined. The movements of the user 60 may include changes in facial expression of the user 60.

The sensor 30 may include the microphone 34. The microphone 34 detects utterances of the user 60 to be outputted as audio data to the server 10. The audio data may include contents of conversation between the users 60 and another user. The audio data may include self-talk of the user 60.

The sensor 30 may include various other devices. For example, the sensor 30 may include a device that is capable of detecting biological information, such as pulses, blood pressures, respiration rates, or perspiration volumes, of the user 60.

The sensor 30 may be installed in a home of the user 60 so as to detect the behavior information when the user 60 is at home. That is, the behavior of the user 60 detected by the sensor 30 may include a behavior that occurs in the home. The user 60 for whom the sensor 30 detects the behavior may include an elderly person, a disabled person, or the like, who lives in the house. The sensor 30 may be included in the terminal apparatus 40 in the possession of the user 60 so as to be able to detect the behavior information regardless of a location of the user 60.

<Server 10>

The server 10 transmits and receives, or outputs and acquires, various types of information related to the provision of the purchase support service to and from other components of the information processing system 1. For example, the server 10 acquires the behavior information from the sensor 30. The server 10 outputs, to the terminal apparatus 40, the product display equipment 22, or the like, the purchase information generated based on the behavior information. The server 10 may be configured to execute, in addition to the above processing, various types of processing related to the provision of the purchase support service. The server 10 is also referred to as an information processing apparatus. The server 10 may include a single server apparatus, or a plurality of server apparatuses capable of communicating with each other.

The server 10 includes a controller 12 and an interface 14.

The controller 12 may include one or more processors. The “processors” in the present embodiment may be, but are not limited to, general-purpose processors, dedicated processors that are dedicated to specific processing, or the like. The controller 12 may include one or more dedicated circuits. Examples of the dedicated circuits may include a Field-Programmable Gate Array (FPGA) and an Application Specific Integrated Circuit (ASIC). The controller 12 may include the dedicated circuits instead of the processors, or may include the dedicated circuits along with the processors. The servers 10 may include a memory. The memory may be, but is not limited to, a semiconductor memory, a magnetic memory, or an optical memory. The memory may function as, for example, a main memory, an auxiliary memory, or a cache memory. The memory may include an electromagnetic storage medium, such as a magnetic disc. The memory may include a non-transitory computer readable medium. The memory may store any information used for operations of the server 10. For example, the memory may store a system program, an application program, or the like. The memory may be included in the controller 12 or may be configured separately from the controller 12.

The interface 14 includes an information acquisition interface 14a and an output interface 14b. The information acquisition interface 14a acquires information. The output interface 14b outputs information. The interface 14 may include a communication module. The communication module is configured to communicate with the sensor 30, the terminal apparatus 40, and the product display equipment 22. The interface 14 that includes the communication module is also referred to as a communication interface.

<Equipment at Shop 20>

The shop 20 includes the product display equipment 22 for displaying products for sale. The product display equipment 22 may include, for example, shelves, flat stands, or the like on which the products are displayed. The product display equipment 22 may include light emitting devices, display devices, audio output devices, or the like that are mounted on the shelves, the flat stands, or the like on which the products are displayed and that output information to emphasize the products. The product display equipment 22 may include robots that display the products. The product display equipment 22 may include robots that place the products into a cart 24 of the user 60.

The shop 20 may further include a product holder in which the user 60 temporarily put products on hold until he or she purchases the products. The product holder may include, for example, the cart 24. The product holder may include, for example, a basket. The product holder is allocated to the user 60 who visits the shop 20. The user 60 may move the product holder by the user 60 himself or herself when moving around in the shop 20. The product holder may be configured to automatically move following the moving user 60. The user 60 can store the products to be purchased in the product holder and finalize the purchase by checking out at a cash register.

<Terminal Apparatus 40>

The terminal apparatus 40 acquires the purchase information from the server 10 and notifies the user 60. For example, the terminal apparatus 40 notifies the user 60 of names, appearances, or the like of the products that are estimated by the server 10 as being required by the user 60. The terminal apparatus 40 may notify the purchase information when the user 60 visits the shop 20.

The terminal apparatus 40 includes a processor that executes processing for implementing various functions. The processor may be configured in the same manner as the processors that constitute the controller 12.

The terminal apparatus 40 includes a terminal interface through which information is acquired and outputted. The terminal interface may include a terminal information acquisition interface through which information is acquired and a terminal output interface through which information is outputted. The terminal information acquisition interface and the terminal output interface are also referred to simply as an information acquisition interface and an output interface of the terminal apparatus 40. The terminal apparatus 40 may include, as the terminal interface, a communication module to connect with the network 50. The communication module may include, but is not limited to, a communication module compatible with a mobile communication standard, such as the 4th Generation (4G) standard or the 5th Generation (5G) standard. The communication module is also referred to as a communication interface of the terminal apparatus 40.

The terminal apparatus 40 may include a positional information detection device that can detect positional information for the terminal apparatus 40 itself. The positional information detection device may include a receiver compatible with a satellite positioning system. The receiver compatible with the satellite positioning system may include, for example, a Global Positioning System (GPS) receiver. The terminal apparatus 40 may detect the positional information for the terminal apparatus 40 itself based on a communication signal received through the communication module. The terminal apparatus 40 may cause the communication module to function as the positional information detection device. The terminal apparatus 40 may determine whether the user 60 is visiting the shop 20 based on the positional information for the terminal apparatus 40 itself.

The terminal apparatus 40 may further include, as the terminal interface, an input device for receiving inputs from the user 60. The input device may include, for example, a touch panel, a keyboard, or the like. The input device may include an audio input device. The audio input device may include the microphone 34 or the like. The input device may be included in the terminal information acquisition interface.

The terminal apparatus 40 may further include an output device for notifying the user 60 of information. For example, the output device may include a display device, or may include an audio output device, such as a speaker. The display device may include various displays, such as a liquid crystal display, a plasma display, or an organic Electro-Luminescence (EL) display or an inorganic EL display. The display device may include a light emitting device, such as a Light Emission Diode (LED). The output device may be included in the terminal output interface.

The terminal apparatus 40 may include, for example, a mobile terminal such as a smartphone. The terminal apparatus 40 may include a portable terminal, such as a tablet Personal Computer (PC) or a notebook PC. The terminal apparatus 40 may include, for example, a desktop PC or the like.

(Operations of Respective Components of Information Processing System 1)

### <Product Estimation>

The controller 12 communicates with the sensor 30 using the interface 14, and acquires the behavior information for the user 60 that has been detected by the sensor 30. The controller 12 estimates the products required by the user 60 based on the behavior information. Specifically, the controller 12 may estimate products of a high interest of the user 60 to be the products required by the user 60, based on the behavior information. The controller 12 may estimate a behavior in which the user 60's interest has increased and may estimate products associated with that behavior to be the products required by the user 60.

<<Estimation Based on Image Data>>

When the behavior information includes image data in which the user 60 is captured, the controller 12 may calculate the line of sight of the user 60 based on the image data. The controller 12 may identify an article or a person located in the line of sight of the user 60 as an object visible to the user 60. The controller 12 may estimate the products required by the user 60 based on the identified visible object. When, for example, the object visible to the user 60 is a storage warehouse for food, daily products, or the like, the controller 12 may estimate products, such as food or daily products, whose remaining quantities are of a concern to the user 60, to be the products required by the user 60.

When, for example, the object visible to the user 60 is a display device, such as a television 70, the controller 12 may identify what content is displayed on the display device when the user 60 is gazing at the display device. In this case, the controller 12 may be communicatively connected to the display device, such as the television 70, using the interface 14, to thereby acquire contents of the content displayed on the display device. The controller 12 may function as a distributor that distributes the content to be displayed by the display device. The controller 12 may estimate the products required by the user 60 based on the content that the user 60 is gazing at. When the user 60 is gazing at advertising content for particular products, the controller 12 may estimate these products to be the products required by the user 60.

<<Estimation Based on Audio Data>>

When the behavior information includes audio data in which utterances of the user 60 are detected, the controller 12 may estimate the products required by the user 60 based on the audio data. The controller 12 may estimate the products required by the user 60 based on contents of the utterances by the user 60, regardless of whether the user 60 is making a murmur of self-talk or talking with others.

For instance, in a case in which the user 60 is talking about a menu for meals, the controller 12 may estimate ingredients for the menu to be the products required by the user 60. For another instance, in a case in which the user 60 is talking about needs in daily life, the controller 12 may estimate products that can satisfy the needs to be the products required by the user 60.

<<Estimation Based on Combined Data>>

The controller 12 may estimate the products required by the user 60 based on data obtained by combining the image data and the audio data. For example, the controller 12 may generate information in which objects visible to the user 60 are associated with contents of utterances, and estimate the products required by the user 60 based on the information. Specifically, the products required by the user 60 may be estimated based on information in which contents of utterances that the user 60 produces while watching the television 70 are associated with contents of the content displayed on the television 70 at the time of the utterances.

The controller 12 may estimate emotions of the user 60 based on the image data. The controller 12 may estimate joy, anger, grief, pleasure, etc. of the user 60. For example, controller 12 may estimate emotions of the user 60 based on the image data in which the appearance, such as facial expressions or complexions, of the user 60 is captured. The controller 12 may estimate the products required by the user 60 based on objects visible to the user 60 at times when the user 60 expresses his or her emotions.

The controller 12 may acquire biological information, such as the state of the pupil of the user 60, based on the image data. Further, the controller 12 may acquire the biological information of the user 60 that is detected by the sensor 30, as the behavior information. The controller 12 may estimate emotions of the user 60 based on the biological information of the user 60. The controller 12 may analyze changes in the biological information of the user 60 and estimate subjects to which behaviors of the user 60 are directed from among objects visible to the user 60, and audio heard from the television 70 or the like and utterances of other people. The controller 12 may estimate the products required by the user 60 based on the subjects to which the behaviors of the user 60 are directed.

<Purchase Support for Estimated Products>

The controller 12 outputs information supporting the purchase of the estimated products, that is, the purchase information. In other words, the controller 12 causes the output interface 14b to output the purchase information. The purchase information is associated with the user 60. The controller 12 may output the purchase information to the product display equipment 22 at the shop 20. The controller 12 may output the purchase information to the terminal apparatus 40 in the possession of the user 60.

<<Operations of Product Display Equipment 22>>

The product display equipment 22 acquires the purchase information from the controller 12. The product display equipment 22 supports, when the user 60 associated with the acquired purchase information visits the shop 20, the user 60 in easily purchasing the products specified by the purchase information.

Specifically, the product display equipment 22 may, for example, change display positions of the products or emphasize the products so that the user 60 can easily find the products. The product display equipment 22 may adjust lights for the products to emphasize the products or cause the surroundings of the products to emit light. The product display equipment 22 may guide the product holder, such as the cart 24, used by the user 60, to the display positions specified by the purchase information associated with the user 60. The product display equipment 22 may automatically store the products in the product holder used by the user 60.

The controller 12 may output control information that causes the product display equipment 22 to perform the above-described operations. The controller 12 may include the control information in the purchase information to be outputted.

<Operations of Terminal Apparatus 40>

The terminal apparatus 40 acquires the purchase information from the controller 12. The terminal apparatus 40 may notify, when the user 60 visits the shop 20, the user 60 of the display positions of the products specified by the purchase information. The terminal apparatus 40 may acquire the display positions of the products specified by the purchase information from the product display equipment 22 using the terminal information acquisition interface and notify the user 60 using the terminal output interface. The terminal apparatus 40 may detect the positional information for the user 60 using the positional information detection device and notify the user 60 when the user 60 enters a predetermined range of the display positions of the products. The terminal apparatus 40 may output, to the product display equipment 22, the positional information for the user 60. The product display equipment 22 may perform the above-described operations based on the positional information for the user 60 that has been acquired from the terminal apparatus 40.

The terminal apparatus 40 may employ Augmented Reality (AR) technologies and superimpose the purchase information on an image of an interior of the shop 20 to thereby allow the user 60 to easily purchase the products.

### SUMMARY

As described above, according to the purchase support service provided by the information processing system 1 according to the present embodiment, the server 10 can generate the purchase information without having to input the products required by the user 60 to the terminal apparatus 40 or the like. This enables a service of generating information to be delivered to the user 60 while saving effort for the user 60.

Further, the user 60 can use the purchase support service without having to utter a special keyword. This increases the convenience for the user 60.

<Example of Flowchart of Information Processing Method>

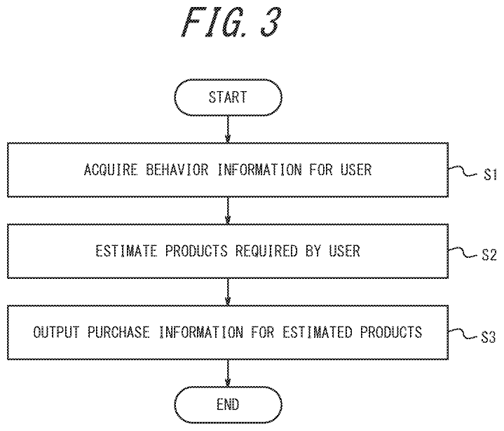

The controller 12 of the server 10 included in the information processing system 1 may execute an information processing method including a procedure shown in the flowchart illustrated in FIG. 3. The information processing method may be implemented as an information processing program to be executed by the processors of the controller 12 or the like. The information processing program may be stored on a non-transitory computer readable medium.

The controller 12 acquires the behavior information for the user 60 (Step S1). Specifically, the controller 12 acquires the behavior information detected by the sensor 30 using the interface 14.

The controller 12 estimates the products required by the user 60 (Step S2). Specifically, the controller 12 may estimate products of a high interest of the user 60 to be the products required by the user 60, based on the behavior information. The controller 12 may estimate a behavior in which the user 60's interest has increased and may estimate products associated with that behavior to be the products required by the user 60.

The controller 12 outputs the purchase information for the estimated products (Step S3). Specifically, the controller 12 may output the purchase information to the product display equipment 22 at the shop 20. Based on the purchase information acquired by the user 60, the product display equipment 22 executes the change of the display positions of the products, the emphasis of the products, or the like. The controller 12 may output the purchase information to the terminal apparatus 40 in the possession of the user 60. The terminal apparatus 40 may notify the user 60 of information related to names or appearances of the products so that the user 60 can recognize the products. After completing the procedure in Step S3, the controller 12 may end the execution of the procedure shown in the flowchart of FIG. 3.

According to the information processing method according to the present embodiment, the purchase information is generated without having to input the products required by the user 60 to the terminal apparatus 40 or the like. This enables the service of generating information to be delivered to the user 60 while saving effort for the user 60.

The embodiment according to the present disclosure has been described based on the drawings and examples. The present disclosure is not limited to the embodiment described above. For example, functions or the like included in each step, or the like, may be rearranged without logical inconsistency, and a plurality steps, or the like can be combined into one, or divided. The present disclosure may be changed without departing from the spirit of the present disclosure.

1. An information processing apparatus, comprising:
an information acquisition interface configured to acquire information related to a behavior of a user; and
a controller configured to estimate a product required by the user based on the information related to the behavior of the user, generate information supporting a purchase of the estimated product, and cause an output interface to output the generated information.

2. The information processing apparatus according to claim 1, wherein
the behavior of the user occurs in a home of the user.

3. The information processing apparatus according to claim 1, wherein
the information acquisition interface is configured to acquire image data in which the user is captured, as the information related to the behavior of the user.

4. The information processing apparatus according to claim 3, wherein
the controller is configured to identify a facial expression and/or a movement of the user based on the image data and estimate the product required by the user based on a result of the identification.

5. The information processing apparatus according to claim 3, wherein
the controller is configured to identify an object visible to the user based on the image data and estimate the product required by the user based on the object visible to the user.

6. The information processing apparatus according to claim 5, wherein
the controller is configured to estimate the product required by the user further based on contents of content identified as the object visible to the user.

7. The information processing apparatus according to claim 1, wherein
the information acquisition interface is configured to acquire audio data including an utterance of the user, as the information related to the behavior of the user, and
the controller is configured to estimate the product required by the user based on the audio data.

8. The information processing apparatus according to claim 7, wherein
the controller is configured to estimate the product required by the user based on contents of a conversation between the user and another user that is included in the audio data.

9. The information processing apparatus according to claim 1, wherein
the controller is configured to output information necessary for the purchase of the estimated product, as control information for product display equipment at a shop on which the product is displayed.

10. The information processing apparatus according to claim 9, wherein
the controller is configured to output, as the control information, information that causes the product display equipment to change a display position of the estimated product.

11. The information processing apparatus according to claim 9, wherein
the controller is configured to output, as the control information, information that causes the product display equipment to emphasize a display position of the estimated product.

12. The information processing apparatus according to claim 9, wherein
the controller is configured to output, as the control information, information that causes the product display equipment to move the estimated product to a product holder used by the user.

13. The information processing apparatus according to claim 1, wherein
the controller is configured to output, to a terminal apparatus in possession of the user, the information supporting the purchase of the estimated product.

14. The information processing apparatus according to claim 13, wherein
the controller is configured to output, to the terminal apparatus, a display position of the estimated product.

15. An information processing method, comprising:
acquiring information related to a behavior of a user;
estimating a product required by the user based on the information related to the behavior of the user; and
outputting information necessary for a purchase of the estimated product.

16. The information processing method according to claim 15, wherein
the behavior of the user occurs in a home of the user.

17. The information processing method according to claim 15, further comprising
acquiring image data in which the user is captured, as the information related to the behavior of the user.

18. The information processing method according to claim 15, further comprising:
acquiring audio data including an utterance of the user, as the information related to the behavior of the user; and
estimating the product required by the user based on the audio data.

19. A terminal apparatus to be in possession of a user, the terminal apparatus comprising:
an information acquisition interface configured to acquire information necessary for a purchase of a product, the product being estimated to be required by the user based on information related to a behavior of the user; and
an output interface configured to notify the user of the information necessary for the purchase of the product.

20. The terminal apparatus according to claim 19, wherein
the information acquisition interface is configured to acquire information related to a display position of the product as the information necessary for the purchase of the product, and
when the user enters a predetermined range of the display position of the product, the output interface notifies the user.
